(19) United States
(12) Patent Application Publication
(10) Pub. No.: US 2006/0201600 A1
(43) Pub. Date: Sep. 14, 2006

(54) Lubricants for run-flat tire systems

(76) Inventor: Edward B. Kollin, Scotch Plains, NJ (US)

Correspondence Address: THE WEINTRAUB GROUP, PLC, Suite 240, 32000 Northwester Hwy., Farmington Hills, MI, 48334, US

(21) Appl. No.: 11/430,621

(22) Filed: May 9, 2006

Related U.S. Application Data
(63) Continuation-in-part of application No. 10/759,450, filed on Jan. 16, 2004, now Pat. No. 7,040,367.
(60) Provisional application No. 60/440,947, filed on Jan. 17, 2003.

(51) Int. Cl. B60C 17/10

(52) U.S. Cl. 152/520; 152/521

(57) ABSTRACT

A lubricant for a run-flat tire system includes a solubilized oil, an oil-miscible or oil-soluble carrier fluid or other non aqueous carrier fluid, a thickener, and a surfactant. The thickening system hereof retains its rheological properties and is not subject to permanent thinning shear. When admixed with optionally, a surfactant and, a lubricity agent, the lubricant exhibits long term viscometric stability (shelf life) and prevents the buildup of heat due to friction in the tire assembly when the tire is in the run-flat condition.

### CROSS-REFERENCE TO RELATED APPLICATIONS

This application is a continuation-in-part application of co-pending U.S. patent application Ser. No. 10/759,450, filed Jan. 16, 2004 which claims priority from Application No. 60/440,947, filed Jan. 17, 2003, for “Lubricants for Run-Flat Tire Systems”, the disclosure of which is hereby incorporated by reference.

### BACKGROUND OF THE INVENTION

1. Field of the Invention

The present invention concerns run-flat tire systems. More particularly, the present invention concerns lubricants for run-flat tire systems. Even more particularly, the present invention pertains to thickened, dry and/or encapsulated lubricants for run-flat tire systems.

2. Prior Art

As is known to those skilled in the art to which the present invention pertains run-flat tires have become prevalent in automobiles to enable the vehicle to remain driveable over a sufficient distance to enable tire repair. Although there exists many configurations for such tires, one of the more promising run-flat tire systems comprises a tire, a wheel rim or wheel, and an interior support ring. The support ring, which is disposed interiorly of the tire, carries the vehicle weight if its associated tire loses pressure. In such instance, when the outside tire collapses it contacts the inner support ring. Typically, the inner support ring is disposed about one to three inches from the interior surface of the tire when the tire is fully inflated.

In order for such run-flat tire or tire system to be effective, it is essential that a lubricant be disposed between the exterior surface of the support ring and the inner surface of the tire. This lubricant is intended to prevent a temperature increase or reduce the rate of temperature increase to an acceptable level, i.e. a level low enough to prevent thermal degradation of any of the elastomeric components of the tire for the manufacturer's specified period of time under its specified conditions. This temperature rise is due to the friction between the support ring and the inner surface of the tire due to their relative motion caused by their differing diameters. Usually, the lubricant is intended to be deposited onto the interior surface of the tire.

Manufacturer's specifications, in addition to temperature increase parameters, require that the lubricant have a gel-like or grease-like consistency so that it will remain in place and not leak or flow while the tire remains in its inflated or non-run-flat condition.

Furthermore, in order for the lubricant to be environmentally acceptable in today's market, it is all but necessary that it be water-based. The art has addressed these issues and created thickened lubricants for meeting these criteria. However, these prior art lubricants still need major improvements. First, ordinarily from about 75 to about 300 grams of lubricant need to be applied to the inside of the tire. Under the best of conditions, this major quantity of the current lubricants required in order to provide an efficacious system, is unacceptable because of wheel balance requirements, cost of lubricant, etc.

Moreover, known run-flat tire thickened lubricants undergo a permanent thinning transformation and, thus, pour like the liquid starting material, when exposed to shear stresses or rubbing under pressure. The shear stress or rubbing occurs because the gap between the support ring and the tire is relatively small and the two occasionally make contact when driving over speed bumps, pot holes, curbs, and the like in a non-run-flat condition. This contact, eventually, causes these prior art lubricants to permanently revert back to a liquid state. After being liquefied by this intermittent contact, if the tire punctures, all of the lubricant runs out and the tire fails prematurely. This can lead to a condition of intermittent tire imbalance necessitating periodic service to replace the lubricant. Or if a new tire goes flat because of a puncture, the shear stress will liquefy the lubricant, through permanent shear thinning, and the liquefied lube will exit the tire helped by inertial forces causing a premature heat related failure of the tire assembly before the manufacturers specifications.

As will be detailed hereinafter, the present invention provides a thickened lubricant which is particularly adapted for utilization in a run-flat tire system.

### SUMMARY OF THE INVENTION

In accordance herewith there is provided, in a first embodiment, a lubricant which generally comprises:
(a) an oil-based base fluid or carrier which is, preferably, a solubilized oil derivative, an oil miscible, an oil-soluble fluid as well as mixtures thereof, alone, or in admixture with a polyhydroxyl compound or other polyhydric compound or other organic compound;
(b) a thickener, thickening agent or thickening system,
(c) optionally, surfactant, and
(d) optionally, a lubricity agent.

The composition may further include activators for the thickener, water and other adjuvants, as noted below.

For a more complete understanding of the present invention reference is made to the following Detailed Description and accompanying non-limitative examples.

### DESCRIPTION OF THE PREFERRED EMBODIMENTS

With more particularity, and as noted above, the first component of the present lubricant is the base fluid or carrier. Also, solubilized oil derivatives, esters, and the like may be used herein as the base fluid. Also, oil-soluble or oil-miscible base fluids may, also, be used herein. Suitable oil-soluble fluids include, for example, mineral oils, synthetic oils, silicone oils, plant derived oils, and the like, as well as emulsions of either, oil-in-water, water-in-oil, or other multi-phase systems. These oil-soluble or miscible fluids, as well as the other solubilized oil derivatives may be used herein, alone, or in admixture with the polyhydric compound.

The oil-based carrier may be used in admixture with a water-soluble polyhydroxyl compound or other polyhydric compounds. Among the useful water-soluble polyhydroxyl compounds are, for example, diols, triols, tetrols, as well as higher polyhydric alcohols and glycol ethers, as well as mixtures thereof.

Representative of the useful polyhydroxyl compounds, are, for example, low molecular weight polyalkylene glycols, such as polyethylene glycols, polypropylene glycols, polybutylene glycols, polyhexylene glycols, etc., as well as glycerin, sorbitol, and the like as well as mixtures thereof may be used herein. By the term “low molecular weight” as used herein is meant a molecular weight ranging from about 60 to about 2000.

It is also contemplated that non-water and/or non-oil as well as oil-soluble polyhydric compounds may be used. These are commonly referred to as polyalkylene glycols, (PAGs).

The preferred carrier or base fluid is dictated by the chemical compatibility with the type of support ring deployed in the tire.

The thickener used herein may be organic or inorganic. Examples of suitable thickeners include clay, kieselguhr earths, cellulosic materials, such as hydroxymethyl cellulose, carboxymethyl cellulose, and waxes, such as carnauba wax, fumed silica, pigments, such as carbon black, and the like.

Other useful thickeners include, for example, polyisobutylene (PIB), soaps such as alkali earth metal soaps, aluminum stearate, polymers such as a polyurea, polyethylene terephthalates, polyethylenes, polycarbohydrates, polycarboxylates, etc., and the like. Also, polyacrylate thickeners may be used.

The thickener used herein may also be a pre-gelled cellulose thickener or an associative-type thickener, used alone or in conjunction with any of the other useful thickeners. Both pre-gelled cellulose and associative thickeners are well-known and commercially available. Associative thickeners, generally, comprise hydrophobically-modified hydroxymethyl cellulose, alkali-swellable emulsions and hydrophobically-modified ethoxylated urethanes. In the practice of the present invention, either the modified cellulose or urethane-type associative thickener may be used. In using such a thickener, generally, it is mixed with a liquid such as water or a polyhydroxyl compound such as a glycol, a triol or the like, as well as mixtures thereof. Generally, from about 1 to about 15 parts thickener to about 85 to about 99 parts liquid is used. Where a liquid mixture is used, it is prepared by mixing the two components together in a weight ratio of about 1 to about 10 parts of water to about 90 to about 99 parts of polyhydroxyl compound.

An activator such as triethanolamine is incorporated herewith. This pre-gelled thickener mixture is then used in small amounts ranging from about 0.5% to 10%, by weight, based on the total weight of the lubricant and is admixed with the lubricant formulation at ambient conditions to define a thickened lubricant having the requisite properties and consistency including viscosity and stickiness necessary to hold the lubricant formulation in place for an extended period of time and which is particularly useful over extended periods of time for up to about five years.

Mixtures of both organic and inorganic thickeners may be used herein.

In the practice of the present invention it is preferred that the thickener be inorganic and specifically, a clay. Among the useful clays are bentonite clay, hectorite clay and the like, as well as mixtures thereof. The preferred clay is bentonite clay.

Optionally, the composition may include a surfactant. The surfactant aids in the thickening of and stabilizes the admixture of carrier and thickener to hold its viscosity.

Useful surfactants include, for example, nonionic, cationic, anionic and amphoteric surfactants. Useful nonionic surfactants include, for example, polyoxyethylene derivatives of suitable polyhydric compounds including alcohols, diols, triols, etc.; ethylene oxide-propylene oxide adducts of ethylene glycol; oxyalkylated alkyl phenols, such as the ethylene oxide adducts of octylphenols and nonylphenols, alkanolamides, ethylene oxide or ethylene oxide/propylene oxide adducts of silicone, amine oxides, alkyl esters, alkylamines, and the like, as well as mixtures thereof.

Examples of useful anionic surfactants include branched and linear alkylbenzene sulfonates, alkyl sulfates, and the like, as well as mixtures thereof.

Representative examples of cationic surfactants include quaternary and amido amine salts.

Useful amphoteric surfactants include the betaines such as alkyl betaines, imidazoline betaines and the like and sultaines such as alkyl hydroxysultaine.

Mixtures of surfactants such as nonionic and anionic, nonionic and cationic, and nonionic and amphoteric surfactants as well as mixtures of cationic and amphoteric and anionic and amphoteric may be used.

Preferably, the surfactant is a silicone surfactant and, preferably, a polyoxyalylene oxide modified silicone sold by GE silicones under the name Silwet 8500.

Carboxylated acrylic copolymer surfactants may also be used herein.

In formulating the present lubricant, the carrier is present in an amount ranging from about 10% to about 95%, by weight, based upon the total weight of the lubricant formulation.

The thickener is present in amount ranging from about 0.5% to about 40%, by weight, based upon the total weight of the formulation.

The surfactant where used, is present in an amount ranging from about 0.1% to 25%, by weight, based upon the total weight of the formulation.

As noted herein above, adjuvants, such as, clay activators, corrosion inhibitors, chelating agents, antibacterial agents, antifungal agents, lubricity enhancers, antioxidants, humectants and the like, as well as mixtures thereof may be incorporated into the lubricant formulation. Where used, minor amounts of the adjuvant are used, they will be present. Generally, the adjuvants are added in amounts ranging from about 0.05% to 30% by weight, based on the total weight of the formulation.

Representative of the lubricity enhancers include, for example, many of the above-noted surfactants, as well as boron derivatives, i.e. boron amides and boric acid, or esters, and silicones etc.

The other adjuvants are well known and commercially available including, for example, glycerin and sorbitol. Many of the polyhydric compounds, such as glycerin and sorbitol are well known humectants. Other humectants include panthenol, quaternium 22 and the like.

Typical anti-bacterial compounds include triclocarbon, bacitracin, chloroxylenol, and so forth. Typical anti-fungal agent, such as o-phenyl phenol, thiabendazol, Imazaril, can be used. Also, the well known and commercially available corrosion inhibitors, chelants, antioxidants and the like may be incorporated hereinto.

The lubricant obtained hereby is a thickened grease or gel-like lubricant which can be directly deposited onto the interior surface of the tire where it can remain for extended periods of time. When the inner surface of the outer tire and the lubricant contacts the support ring, due to a bump on the road or the like, the lubricant undergoes substantial temporary shear thinning, and then returns to substantially its starting viscosity. Generally, the thickened lubricant hereof will have a viscosity above 100,000 cps at 25° C. and 1-20 RPM as measured with a Brookfield viscometer.

Stated otherwise, the lubricant hereof can be classified by NLGI consistency numbers as falling between ASTM Worked Penetration of 85 corresponding to NLGI #6 to a Worked Penetration of 475 corresponding to NLGI #000.

Generally, from about 50 to about 150 grams of lubricant is deposited onto the tire interior.

It should be noted that after the lubricant is prepared, its viscosity may be adjusted downward by the addition of minor amounts of the base fluid.

Alternatively, the lubricant hereof can be encapsulated in a gelatin or other water-soluble capsule, such as disclosed in U.S. Pat. No. 3,927,196; 5,250,344 and 6,358,296, the disclosures of which are hereby incorporated by reference.

After preparation, the encapsulated lubricant is applied to the support ring where it remains in place.

Because of the rubbing between the interior of the tire and the support ring where there is contact, shear thinning occurs to lower the viscosity of the thickened lubricant and thus minimize the build up of heat in the tire assembly thereby allowing the possibility of repair of the tire system. Furthermore, at shear rates of 10 to 100,000 reciprocal seconds, the present lubricant does not undergo permanent shear thinning but temporary shear thinning in the contact zone followed by rapid rebuild and viscometric recovery when the shear stresses are removed. i.e. the tire rotates and the contact zone shifts

In preparing the lubricant, the glycol, clay, activator and water are mixed together at ambient conditions in a high-speed blender. Thereafter, this mixture is passed through a colloid mill to shear the clay and form the grease. Next, the surfactant is added. Then, a minor amount of additional glycol can be added to adjust the viscosity.

A suitable quantity of the gel-like lubricant is then applied to the interior of the tire carcass.

It is apparent from the preceding that there has been described herein a lubricant which is efficacious for use in a run-flat tire system as well as in other environments.

Furthermore, it is contemplated that a dry formulation having incorporated therein polytetrafluoroethylene (Teflon), graphite, molybdenum disulfide, boron nitride and the like may admixed therewith in the form of polymers or solids to provide the dry lubricant system.

Having thus described the invention, what is claimed is:

1. A run-flat tire, comprising:
(a) an outer tire;
(b) an inner support ring, disposed interiorly of the carcass and having a surface facing the interior surface of the tire; and
(c) a lubricant disposed between the facing surface and the interior of the tire, the lubricant comprising:
(1) a carrier fluid selected from the group consisting of a solubilized oil, an oil-soluble fluid, an oil-miscible fluid and mixtures thereof;
(2) a thickener;
wherein the lubricant has an initial viscosity above 100,000 centipoises at 25° C. and from 1 to 20 RPM as measured with a Brookfield viscometer, the lubricant undergoing temporary shear thinning and returning to substantially its starting viscosity after contact between an inner surface of an outer tire and a support ring of the run-flat tire.

2. The run-flat tire of claim 1 wherein the carrier fluid is selected from the group consisting of mineral oils, synthetic oils, silicone oils, high propylene oxide PAGs, plant-derived oils, oil-in-water, and water-in-oil emulsions.

3. The run-flat tire of claim 2 wherein the carrier fluid is in admixture with a second carrier fluid which is a polyhydroxyl compound selected from the group consisting of diols, triols, tetrols, polyhydric alcohols, glycol ethers and mixtures thereof.

4. The run-flat tire of claim 2 wherein the carrier is present in amount ranging from about 10% to about 95%, by weight, based on the total weight of the lubricant.

5. The run-flat tire of claim 2 wherein the thickener is selected from the group consisting of a clay, kieselguhr earths, a cellulosic material, a pre-gelled cellulose, an associative-type thickener, a wax, fumed silica, pigments, polyisobutylene, an alkali earth metal soap, aluminum stearate, polyurea, polyethyleneterephthalate, polyethylenes, polycarbohydrates, polycarboxylates, polyacrylates, and mixtures thereof.

6. The run-flat tire of claim 5 wherein the thickener is a clay.

7. The run-flat tire of claim 6 wherein the clay is selected from the group consisting of bentonite clay, hectorite clay and mixtures thereof.

8. The run-flat tire of claim 5 wherein the thickener is present in an amount ranging from 0.5% to about 40%, by weight, based on the total weight of the lubricant.

9. The run-flat tire of claim 2 wherein the surfactant is a silicone surfactant.

10. The lubricant of claim 9 wherein the surfactant is an alkoxylated silicone.

11. The lubricant of claim 3 wherein:
(a) the second carrier fluid is present in an amount ranging from about 1.0% to about 50%, by weight, based upon the total weight of the lubricant and is selected from the group consisting of polyethylene glycols, polypropylene glycols, polybutylene glycols, polyhexylene glycols, glycerin, sorbitol and mixtures thereof;
(b) the thickener is a clay selected from the group consisting of bentonite clay, hectorite clay, and mixtures thereof, the clay being present in an amount ranging from about 0.5% to about 40%, by weight, based upon the total weight of the lubricant; and
(c) the surfactant is an alkoxylated silicone surfactant.
